(19) United States
(12) Patent Application Publication
(10) Pub. No.: US 2025/0260799 A1
(43) Pub. Date: Aug. 14, 2025

(54) DISPLAY DEVICE AND DRIVING METHOD THEREOF

(71) Applicant: SAMSUNG ELECTRONICS CO., LTD., Suwon-si (KR)

(72) Inventors: Younghoon CHO, Suwon-si (KR); Jiyong Park, Suwon-si (KR); Gwangho Lee, Suwon-si (KR)

(73) Assignee: SAMSUNG ELECTRONICS CO., LTD., Suwon-si (KR)

(21) Appl. No.: 19/192,920

(22) Filed: Apr. 29, 2025

Related U.S. Application Data
(63) Continuation of application No. PCT/KR2023/016389, filed on Oct. 20, 2023.

(30) Foreign Application Priority Data
Dec. 14, 2022 (KR) 10-2022-0174669

(51) Int. Cl. H04N 13/344; G09G 3/20; G09G 3/32; H04N 13/172; H04N 13/327; H04N 13/398

(52) U.S. Cl. CPC H04N 13/344; G09G 3/2096; G09G 3/32; H04N 13/172; H04N 13/327; H04N 13/398; G09G 2310/08; G09G 2320/0233; G09G 2320/0242; G09G 2320/0653; G09G 2320/0666; G09G 2320/0693; H04N 2213/008

(57) ABSTRACT

Disclosed is a display device including a display including a plurality of LED pixels and a driver. The display device identifies at least one of a magnitude of a current or an application time of the current to be applied to the plurality of LED pixels based on luminance information of an input image. Based on the input image being identified as a two-dimensional (2D) image, the display device controls the driver to control the current to be applied to the plurality of LED pixels based on the identified at least one of the magnitude of the current or the application time of the current, and based on the input image being identified as a three-dimensional (3D) image, controls the driver to obtain a left image and a right image included in the input image and alternately display the left image and the right image.

### CROSS-REFERENCE TO RELATED APPLICATIONS

This application is a continuation application of International Application No. PCT/KR2023/016389, filed on Oct. 20, 2023, which claims priority to Korean Patent Application No. 10-2022-0174669, filed on Dec. 14, 2022, in the Korean Intellectual Property Office, the disclosures of which are incorporated by reference herein in their entireties.

### BACKGROUND

### 1. Field

The present disclosure relates to a display device and a driving method thereof, and more particularly to, a display device including a plurality of LED pixels and a driving method thereof.

### 2. Description of Related Art

A light emitting diode (LED) is a semiconductor light emitting device that converts electric current into light. Recently, as the luminance of LEDs has gradually increased, their use as light sources for displays, automobiles, and lighting has increased, and it is possible to realize LEDs that emit white light with high efficiency by using fluorescent materials or combining LEDs of different colors. If the current applied to these LEDs is increased or the application time is increased, images can be displayed with high luminance.

### SUMMARY

According to an aspect of the disclosure, there is provided a display device including: a display including a plurality of LED pixels; a driver configured to drive the display by applying a current to the plurality of LED pixels; a communication interface; memory storing at least one instruction; and one or more processors connected to the display, the communication interface and the memory, wherein the at least one instruction, when executed by the one or more processors, cause the display device to: identify at least one of a magnitude of a current or an application time of the current to be applied to the plurality of LED pixels based on luminance information of an input image; based on the input image being identified as a two-dimensional (2D) image, control the driver to control the current to be applied to the plurality of LED pixels based on the identified at least one of the magnitude of the current or the application time of the current; based on the input image being identified as a three-dimensional (3D) image, control the driver to obtain a left image and a right image included in the input image and alternately display the left image and the right image; generate a 3D synchronization signal corresponding to a display timing of the left image and the right image, and transmit the generated 3D synchronization signal to 3D glasses through the communication interface; and control the driver to increase the identified at least one of the magnitude of the current or the application time of the current while the left image and the right image are displayed.

The at least one instruction, when executed by the one or more processors, may cause the display device to identify whether the input image is a 3D image based on at least one of header information of the input image, resolution information of the input image or frame rate of the input image.

The at least one instruction, when executed by the one or more processors, may cause the display device to, based on the input image being identified as the 3D image, increase at least one of the identified magnitude of the current or the application time of the current so that luminance of the input image increases by a preset ratio while the left image and the right image are displayed.

The preset ratio is identified based on a luminance reduction rate resulting from alternately displaying the left image and the right image and a luminance reduction rate according to transmittance of the 3D glasses.

The display may include a plurality of display modules; wherein the driver may include a plurality of driving modules connected to the plurality of display modules; and wherein the at least one instruction, when executed by the one or more processors, may cause the display device to adjust the preset ratio based on peak luminance information corresponding to each of the plurality of display modules.

The at least one instruction, when executed by the one or more processors, may cause the display device to, based on at least one of peak luminance information corresponding to each of the plurality of display modules being lower than a luminance corresponding to the preset ratio, adjust the preset ratio based on the at least one peak luminance information.

The at least one instruction, when executed by the one or more processors, may cause the display device to: based on the 3D glasses being communicatively connected to another 3D glasses, receive transmittance information of the another 3D glasses from the another 3D glasses through the communication interface; and identify the preset ratio based on the received transmittance information and a luminance reduction rate resulting from alternately displaying the left image and the right image.

The at least one instruction, when executed by the one or more processors, may cause the display device to: based on the 3D glasses being communicatively connected to a plurality of 3D glasses, receive a plurality of transmittance information from the plurality of 3D glasses through the communication interface; identify representative transmittance information based on at least one of a minimum value, a maximum value, an average value, or a median value of the received plurality of transmittance information; and identify the preset ratio based on the identified representative transmittance information and a luminance reduction rate resulting from alternately displaying the left image and the right image.

According to an aspect of the disclosure, there is provided a controlling method of a display device including a display that includes a plurality of LED pixels, the method including: identifying at least one of a magnitude of a current or an application time of the current to be applied to the plurality of LED pixels based on luminance information of an input image; based on the input image being identified as a two-dimensional (2D) image, controlling the current to be applied to the plurality of LED pixels based on the identified at least one of the magnitude of the current or the application time of the current; based on the input image being identified as a three-dimensional (3D) image, obtaining a left image and a right image included in the input image and alternately displaying the left image and the right image; generating a 3D synchronization signal corresponding to a display timing of the left image and the right image, and transmitting the generated 3D synchronization signal to 3D glasses; and increasing the identified at least one of the magnitude of the current or the application time of the current while the left image and the right image are displayed.

The controlling method may include: identifying whether the input image is a 3D image based on at least one of header information of the input image, resolution information of the input image or frame rate of the input image.

The increasing at least one of the magnitude of the current or the application time of the current may include, based on the input image being identified as a 3D image, increasing at least one of the identified magnitude of the current or the application time of the current so that luminance of the input image increases by a preset ratio while the left image and the right image are displayed.

The preset ratio is identified based on a luminance reduction rate resulting from alternately displaying the left image and the right image and a luminance reduction rate according to transmittance of the 3D glasses.

The display device may include a plurality of display modules and a plurality of driving modules connected to the plurality of display modules; and wherein the controlling method may include: adjusting the preset ratio based on peak luminance information corresponding to each of the plurality of display modules.

The controlling method may include: based on at least one of peak luminance information corresponding to each of the plurality of display modules being lower than a luminance corresponding to the preset ratio, adjusting the preset ratio based on the at least one peak luminance information.

According to an aspect of the disclosure, there is provided a non-transitory computer-readable recording medium storing a computer instruction that, when executed by a processor of a display device including a display that includes a plurality of LED pixels, causes the display device to: identify at least one of a magnitude of a current or an application time of the current to be applied to the plurality of LED pixels based on luminance information of an input image; based on the input image being identified as a 2D image, control the current to be applied to the plurality of LED pixels based on the identified at least one of the magnitude of the current or the application time of the current; based on the input image being identified as a 3D image, obtain a left image and a right image included in the input image and alternately display the left image and the right image; generate a 3D synchronization signal corresponding to a display timing of the left image and the right image, and transmit the generated 3D synchronization signal to 3D glasses; and increase the identified at least one of the magnitude of the current or the application time of the current while the left image and the right image are displayed.

### BRIEF DESCRIPTION OF THE DRAWINGS

FIG. 1 is a block diagram provided to explain a 3D image and 3D glasses according to an embodiment;

FIG. 2A is a block diagram illustrating configuration of a display device according to an embodiment;

FIG. 2B is a view provided to explain a case in which a display device includes a plurality of display modules according to an embodiment;

FIG. 2C is a block diagram illustrating detailed configuration of a display device according to an embodiment;

FIG. 3 is a block diagram provided to explain an operation of a display device 3 according to an embodiment;

FIG. 4 is a view provided to explain a controlling method of a display device according to an embodiment;

FIGS. 5A to 5D are views provided to explain a 3D image according to an embodiment;

FIG. 6 is a block diagram provided to explain a process of identifying a 3D image according to an embodiment;

FIGS. 7A to 7D are views provided to explain a process of obtaining a left image and a right image included in an input image according to an embodiment;

FIG. 8 is a view provided to explain a luminance adjustment module according to an embodiment; and

FIG. 9 is a view provided to explain a case where there are a plurality of 3D glasses according to an embodiment.

### DETAILED DESCRIPTION

The embodiments of the present disclosure may be modified in various ways, and may have various embodiments, so specific embodiments are illustrated in the drawings and described in detail in the detailed description. However, it is to be understood that the disclosure is not limited to specific exemplary embodiments, but include all modifications, equivalents, and/or alternatives according to exemplary embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope of the technical spirit of the disclosure is not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

Meanwhile, various elements and regions in the drawings are schematically drawn in the drawings. Therefore, the technical concept of the disclosure is not limited by a relative size or spacing drawn in the accompanying drawings.

Hereinafter, an embodiment according to the present disclosure will be described in detail with reference to the accompanying drawings so that a person with ordinary knowledge in the technical field to which the present disclosure belongs can easily implement the present disclosure.

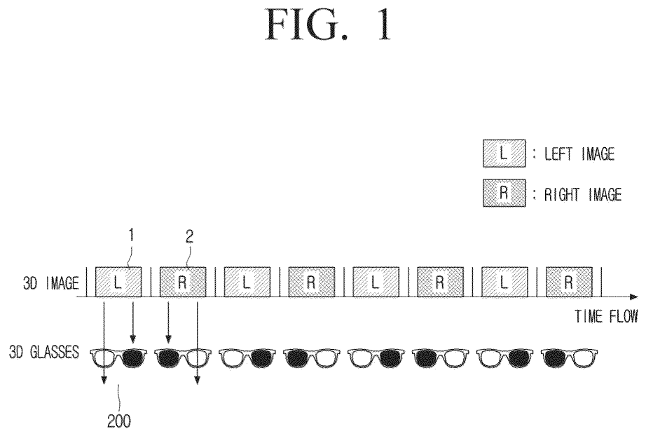

FIG. 1 is a block diagram to illustrate a method for providing a glasses-type 3D image according to an embodiment.

Referring to FIG. 1, a 3D image is provided by alternately displaying a left image 1 and a right image 2, and the left image 1 and the right image 2 are displayed sequentially within a single frame section so that a user can perceive them as one 3D.

3D glasses 200 may be operated in synchronization with the display timing of the left image 1 and the right image 2.

When the left image 1 is displayed on the display, the left lens of the 3D glasses 200 may be in an open state and the right lens may be in a closed state. Thus, when the left image 1 is displayed on the display, the user can view the left image 1 through the left lens of the 3D glasses 200.

When the right image 2 is displayed on the display, the left lens of the 3D glasses 200 may be in a closed state and the right lens may be in an open state. Thus, when the right image 2 is displayed on the display, the user can view the right image 2 through the right lens of the 3D glasses 200.

As such, the user can view the 3D image by alternately recognizing the left image and the right image. Meanwhile, when the left image 1 and the right image 2 are provided alternately, the image is perceived by the user through one lens of the 3D glasses 200, so it may be perceived at a lower luminance than the luminance of the actual image. Also, since the provided image is perceived by the user by passing through the lens of the 3D glasses 200, it may be perceived at a lower luminance than the actual luminance of the image due to the light transmittance of the lens itself.

Accordingly, hereinafter, various embodiments in which the luminance of the actual image can be perceived by the user without degradation of the luminance of the actual image when providing a glasses-type 3D image will be described.

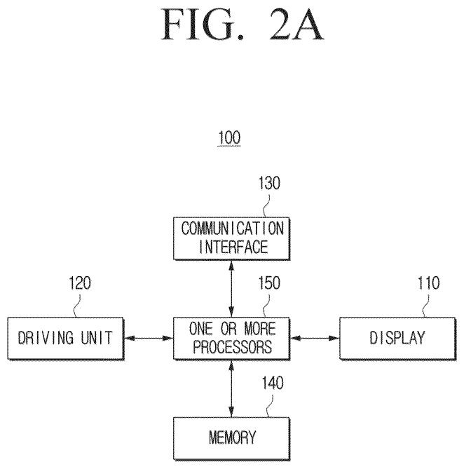

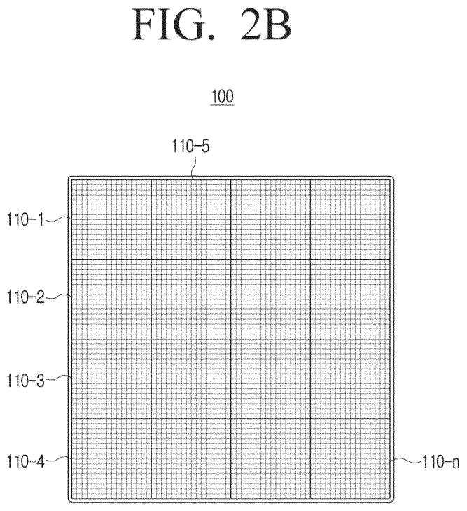

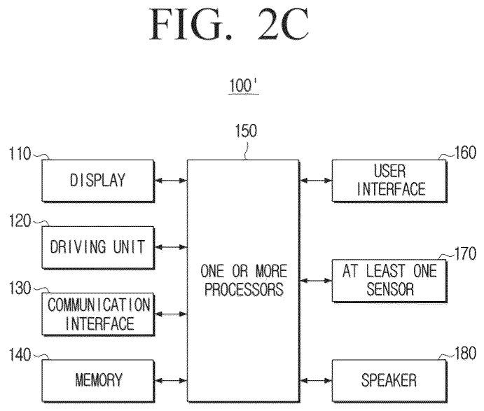

FIG. 2A is a block diagram illustrating configuration of a display device according to an embodiment.

Referring to FIG. 2A, a display device 100 may include a display 110, a driving unit 120 (e.g., driver), a communication interface 130, memory 140, and one or more processors 150. However, the configuration of the display device 100 shown in FIG. 2A is only an example of one embodiment, and other configurations may be added or some configurations may be omitted.

The display 110 may display various information related to the operation of the display device 100. To this end, the display 110 may include various types of display panels, such as, but not limited to, liquid crystal display (LCD) panels, organic light emitting diodes (OLED) panels, active-matrix organic light-emitting diodes (AM-OLED), liquid crystal on silicon (LcoS), quantum dot light-emitting diodes (QLED) and digital light processing (DLP), plasma display panel (PDP) panels, inorganic LED panels, micro LED panels, and the like. Meanwhile, the display 110 may be configured as a touch screen with a touch panel, and may be formed as a flexible panel. According to an embodiment, the display 110 may be implemented as a flat display, a curved display, a flexible display capable of folding or/and rolling, etc.

FIG. 2B is a view provided to explain a case in which the display device 110 is implemented as a self-luminous display panel, particularly, an LED panel, according to an embodiment.

Referring to FIG. 2B, the display 110 may include a plurality of display modules. In particular, the display 110 may be configured in a form in which a plurality of display modules 110-1, . . . 110-n are connected and assembled. Here, each of the plurality of display modules may include a plurality of pixels, for example, self-luminous pixels, arranged in a matrix form. According to an embodiment, the display 110 may be implemented as a plurality of LED modules (an LED module including at least one LED element) and/or a plurality of LED cabinets. In addition, the LED module may include a plurality of LED pixels, and according to an embodiment, the LED pixel may be implemented as an RGB LED, and the RGB LED may include a RED LED, a GREEN LED, and a BLUE LED together.

The driving unit 120 drives the display 110 under the control of the one or more processors 150. For example, the driving unit 120 drives each LED pixel by applying driving voltage or flowing driving current to drive each self-luminous element, for example, an LED pixel, which constitutes the display panel 110 under the control of the processor 150.

Meanwhile, the driving unit 120 may include a plurality of driving modules connected to the plurality of display modules 110-1, . . . 110-n. For example, one display module 110-1 (e.g., a cabinet or module) may be divided into a plurality of display areas, and a plurality of driving modules may be connected to the plurality of display areas, respectively. The plurality of driving modules may supply driving current to each of the plurality of display areas in response to each control signal input from the one or more processors 150. Specifically, the plurality of driving modules may adjust at least one of a supply time or intensity of the driving current supplied to the plurality of display areas in response to each control signal input from the one or more processors 150.

According to an embodiment, a power supply is hardware that converts alternating current into direct current for reliable use in each of the plurality of display modules 110-1, . . . 110-n and supplies power to each system according to the system. The power supply may largely consist of an input electromagnetic interference (EMI) filter section, an AC-DC rectifier section, a DC-DC switching converter section, an output filter, and an output section. The power supply may be implemented as a switched mode power supply (SMPS), for example. The SMPS is a DC-stabilized power supply device whose output is stabilized by controlling the on-off time ratio of semiconductor switching elements, which enables high efficiency, compactness, and light weight, and may be used to drive each of the plurality of display modules 110-1, . . . 110-n. However, according to another embodiment, the driving unit 120 may be implemented in the form of a single driving module that separately drives a plurality of SMPSs that supply power to each of the plurality of display modules 110-1, . . . 110-n.

The memory 130 may store data required for various embodiments of the present disclosure. The memory 130 may be implemented as a memory embedded in the display device 100 or as a memory detachable from the display device 100 depending on the data storage purpose. For example, in the case of data for driving the display device 100, the data may be stored in the memory embedded in the display device 100, and in the case of data for the expansion function of the display device 100, the data may be stored in the memory detachable from the display device 100. Meanwhile, the memory embedded in the display device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the display device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

Meanwhile, the memory 130 may store current information of the plurality of display modules 110-1, . . . , 110-n. Here, the current information may be current control information according to the luminance of each sub-pixel constituting the display module. Here, the current control information according to the luminance of each sub-pixel may be current control information according to the luminance of each sub-pixel that is calibrated (modeled) based on the luminance characteristics and color shift characteristics according to the current of each sub-pixel.

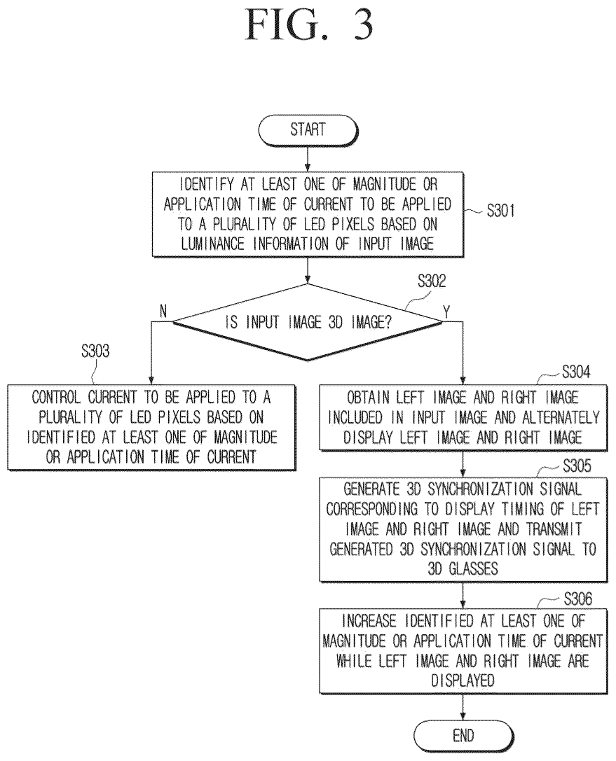

Specifically, the current control information according to the luminance of each sub-pixel may be the current gain information according to the luminance of each sub-pixel calibrated based on the luminance level information according to the current of each sub-pixel and the color shift information according to the current of each sub-pixel. For example, the luminance level information according to the current for each sub-pixel may be the luminance change information according to the current change for each R/B/G LED element, and the color information according to the current for each sub-pixel may be the degree of change in the color coordinates (e.g., x, y color coordinates) according to the current change for each R/B/G LED element. In this case, the current gain information according to the luminance for each sub-pixel may be the current gain value according to the luminance of each sub-pixel obtained by calibrating the current value so that the amount of luminance change for each R/B/G LED element according to the current change is similar, while the color shift phenomenon for each R/B/G LED element according to the current change does not occur. For example, as illustrated in FIG. 3A, the current gain information according to the luminance of each sub-pixel may include the current gain value according to the luminance of each sub-pixel calibrated based on the luminance and color characteristics of each sub-pixel according to the current increase. However, the present disclosure is not limited thereto, and the current control information may be the current value itself, not the current gain value.

Further, the memory 130 may store luminance level information according to the power supplied to a display module. In other words, as the power supplied to the display module increases, the luminance of the display module also increases, but when the supplied power exceeds a preset threshold value, the luminance increase rate of the display module gradually decreases and does not increase more than a maximum luminance value. Subsequently, information about the luminance change amount of the display module according to the supply power change amount can be pre-measured and stored in the memory 130. In this case, the luminance level information according to the power can be luminance increase amount information according to the power increase amount. However, even if the information is not in this form, any information indicating the relationship between the supply power and the luminance is applicable without limitation.

In addition, the memory 130 may store power information of each sub-pixel for each grayscale. Since the grayscale of an image is related to the luminance value, the power of each R/G/B LED element required to represent an image of a preset grayscale changes. As such, the power information of each R/G/B LED element for each grayscale of the image may be stored in the memory 130. For example, the power information of each R/G/B LED element for each grayscale value of 255 (where the image has 256 grayscale levels for each color signal in RGB) or 1024 (where the image has 1024 grayscale levels for each color signal in RGB) may be stored in the memory 130. Such power information for each grayscale may be pre-measured and stored in the memory 130. In other words, the power information for each grayscale may be obtained by measuring the amount of power consumed by the R/G/B LED elements while displaying the image for each grayscale on the display module. For example, as shown in FIG. 3B, when each of the R/G/B LED elements represents each grayscale value of 1024 grayscale, the amount of power consumed may be different. In general, the power required to represent the same grayscale value is relatively greater for the red LED element compared to the green LED element and the blue LED element, while the green LED element and the blue LED element require approximately the same power to represent the same grayscale value.

In addition, the memory 130 may store information about a binning group, information about maximum luminance per pixel, information about a color per pixel, a luminance correction coefficient per pixel, and the like. Here, the binning group may be, in the case of LED pixels, a group of LED pixels having the same characteristics as much as possible (luminance, color coordinates, etc.).

For example, in order to achieve uniformity characteristics between multiple LED pixels, the luminance is adjusted downward through calibration using a luminance correction coefficient to match the maximum luminance to the target luminance. In this case, the luminance correction coefficient may be in the form of a 3*3 matrix for implementing the target R/G/B luminance, and by applying different luminance correction coefficients to each pixel, the maximum luminance becomes the target luminance, thereby implementing uniformity. In addition, the color temperature can also be calibrated to have uniformity while implementing the target luminance based on the parameters in the form of a 3*3 matrix corresponding to each R/G/B element.

The memory 130 may further store information about the number of pixels constituting each of the plurality of display modules, the size of the pixels, and the spacing between the pixels.

Meanwhile, according to another embodiment, the above-described information stored in the memory 130 may be obtained from an external device rather than being stored in the memory 130. For example, some of the information may be received in real time from an external device such as a set-top box, an external server, a user terminal, or the like.

The communication interface 140 performs communication with an external device and receives various types of data and information. For example, the communication interface 140 may receive various types of data and information from home appliances (e.g., display devices, air conditioners, air purifiers, etc.), external storage media (e.g., USB memory), external servers (e.g., web hard), etc. through communication methods such as AP-based Wi-Fi (Wireless LAN network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), optical, coaxial, etc. In particular, the display device 100 may perform communication with 3D glasses through the communication interface 140.

The one or more processors 150 control the operation of the display device 100. Specifically, the one or more processors 150 may be connected to each component of the display device 100 and control the overall operations of the display device 100. For example, the one or more processors 140 may be electrically connected to the display 110 and the memory 130 and control the overall operations of the display device 100. The processor 150 may consist of one or multiple processors.

By executing at least one instruction stored in the memory 130, the one or more processors 150 may perform the operations of the display device 100 according to various embodiments.

The one or more processors 150 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 150 may control one or any combination of the other components of the electronic device, and may perform communication-related operations or data processing. The one or more processors 150 may execute at least one program or instruction stored in the memory. For example, the one or more processors may perform a method according to an embodiment by executing at least one instruction stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 150 may be implemented as a single core processor including a single core or as one or more multicore processors including a plurality of cores (e.g., homogeneous multicore or heterogeneous multicore). When the one or more processors 150 are implemented as a multicore processor, each of the plurality of cores included in the multicore processor may include internal memory of the processor such as cache memory and an on-chip memory, and a common cache shared by the plurality of cores may be included in the multicore processor. Each of the plurality of cores (or some of the plurality of cores) included in the multicore processor may independently read and perform program instructions to implement the method according to an embodiment, or all (or some) of the plurality of cores may be coupled to read and perform program instructions to implement the method according to an embodiment.

In the embodiments of the present disclosure, the processor may mean a system-on-chip (SoC) in which one or more processors and other electronic components are integrated, a single-core processor, a multi-core processor, or a core included in a single-core processor or a multi-core processor, and here, the core may be implemented as CPU, GPU, APU, MIC, DSP, NPU, hardware accelerator, or machine learning accelerator, etc., but the core is not limited to the embodiments of the present disclosure. Hereinafter, for convenience of explanation, the one or more processors 150 will be referred to as the processor 150.

FIG. 2C is a block diagram illustrating an implementation example of an electronic device according to an embodiment.

Referring to FIG. 2C, a display device 100′ may include the display 110, the driving unit 120, the communication interface 130, the memory 140, the one or more processors 150, a user interface 160, at least one sensor 170, and a speaker 180. Hereinafter, detailed descriptions of the parts that overlap with those in FIG. 2A will be omitted.

The user interface 160 may be implemented as a device such as a button, a touch pad, a mouse, and a keyboard, or a touch screen that can also perform a display function and a manipulation input function.

The at least one sensor 170 may obtain various data related to the user of the display device 100. According to an embodiment, the at least one sensor 170 may include a GPS capable of obtaining location data of the display device 100, an acceleration/gyro sensor capable of obtaining movement data of the display device 100, a temperature sensor, a humidity sensor, an image sensor capable of taking pictures, a grip sensor, a proximity sensor, a color sensor, an infrared (IR) sensor, a biometric sensor, an illuminance sensor, a gesture sensor, an air pressure sensor, or a magnetic sensor.

The speaker 180 may be configured to output various audio data as well as various notification sounds or voice messages. The processor 150 may control the speaker 180 to output feedback or various notification sounds in audio form according to various embodiments of the present disclosure.

In addition, the display device 100′ may include a camera (not shown), a microphone (not shown), a tuner (not shown), and a demodulator (not shown) depending on the implementation example.

The camera (not shown) may be turned on in response to a preset event to perform shooting. The camera (not shown) may be used to recognize the user's gesture command or to obtain surrounding context information.

The microphone (not shown) is configured to receive a user voice or other sound and convert it into audio data. However, according to another embodiment, the display device 100′ may receive a user voice input through an external device through the communication interface 150.

The tuner (not shown) may receive a radio frequency (RF) broadcast signal by tuning to a channel selected by the user or all previously stored channels among RF (Radio Frequency) broadcast signals received through an antenna.

The demodulator (not shown) may receive and demodulate a digital IF signal (DIF) converted from the tuner, and may also perform channel decoding, etc.

FIG. 3 is a block diagram provided to explain an operation of a display device according to an embodiment.

Referring to FIG. 3, the processor 150 may, by executing at least one instruction, identify at least one of a magnitude of current applied to the plurality of LED pixels or an application time based on luminance information of the input image (S301).

Subsequently, the processor 150 may identify whether the input image is a 3D image (S302). According to an embodiment, the processor 150 may identify whether the input image is a 3D image based on at least one of header information of the input image, resolution information of the input image, or a frame rate of the input image.

When it is identified that the input image is a 2D image, the processor 150 may control the driving unit 120 to control the current applied to the plurality of LED pixels based on at least one of the identified magnitude or application time of the current (S303).

Alternatively, when it is identified that the input image is a 3D image, the processor 150 may obtain a left image and a right image included in the input image and alternately display the left image and the right image on the display 110 (S304).

Subsequently, the processor 150 may generate a 3D synchronization signal corresponding to the display timing of the left image and the right image, and transmit the generated 3D synchronization signal to the 3D glasses through the communication interface 130 (S305).

Then, the processor 150 may control the driving unit 120 such that at least one of the identified magnitude or application time of the current is increased while the left image and the right image are displayed (S306). According to an embodiment, the processor 150 may increase at least one of the identified magnitude or application time of the current such that, when it is identified that the input image is a 3D image, the luminance of the input image is increased by a preset ratio while the left image and the right image are displayed. Here, the preset ratio may be identified based on the luminance reduction rate resulting from alternately displaying the left image and the right image and the luminance reduction rate due to the transmittance of the 3D glasses.

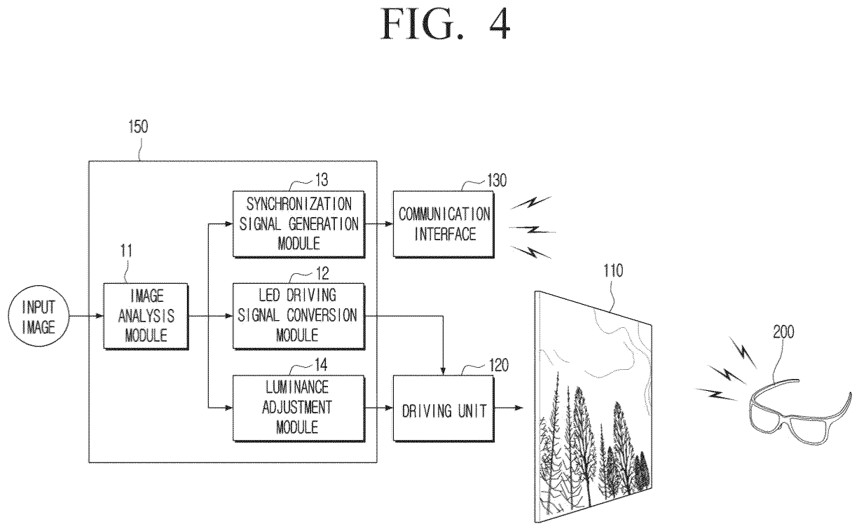

Such operation of the processor 150 may consist of the operation of an image analysis module 11, an LED driving signal conversion module 12, a synchronization signal generation module 13, and a luminance adjustment module 14. Hereinafter, the operation of the image analysis module 11, the LED driving signal conversion module 12, the synchronization signal generation module 13, and the luminance adjustment module 14 will be described with reference to FIG. 4.

FIG. 4 is a view provided to explain a controlling method of a display device according to an embodiment.

Referring to FIG. 4, the processor 150 may control the display device using the image analysis module 11, the LED driving signal conversion module 12, the synchronization signal generation module 13, and the luminance adjustment module 14. Here, each module may be implemented as at least one software, at least one hardware, and/or a combination thereof.

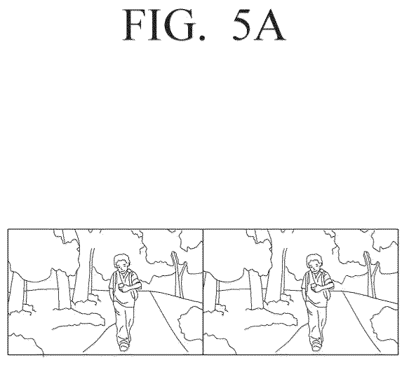

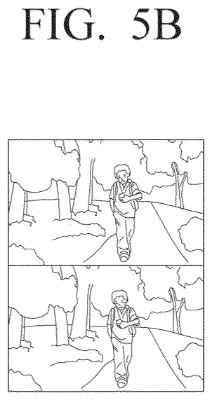

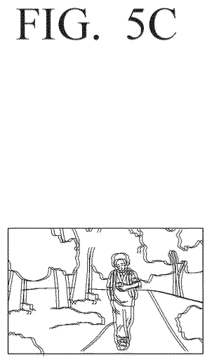

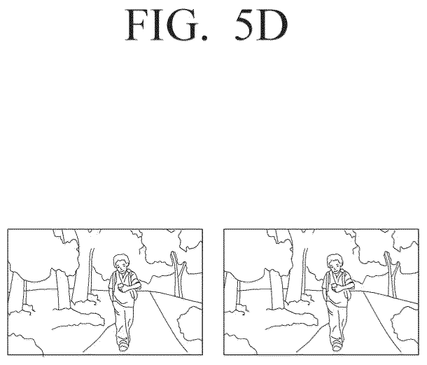

According to an embodiment, the processor 150 may receive an input image using the image analysis module 11. Here, the input image may be a 2D image or a 3D image. Hereinafter, a 3D image will be described with reference to FIGS. 5A to 5D.

FIGS. 5A to 5D are views provided to explain a 3D image according to an embodiment.

According to an embodiment, a 3D image may be received in which left and right images are mixed in various ways. For example, a 3D image may be received in a form in which the left and right images are mixed in one of the following methods: side by side, top by bottom, interlaced, and solo left and solo right.

For example, as shown in FIG. 5A, a 3D image may be composed of two 2D images that constitute one frame of the image in a side by side manner. In other words, a 3D image may be composed of a left 2D image on the left side of the image and a right 2D image on the right side of the image. Accordingly, the resolution of the 3D image may be greater than the resolution of one 2D image. For example, when the resolution of the 2D image is 1920×1080, the resolution of the 3D image may be 3840×1080.

Referring to FIG. 5B, a 3D image may be composed of a left 2D image at the top of the image and a right 2D image at the bottom of the image in a top by bottom manner. Accordingly, the resolution of the 3D image may be greater than the resolution of one 2D image. For example, when the resolution of the 2D image is 1920×1080, the resolution of the 3D image may be 1920×2160.

Referring to FIG. 5C, a 3D image may be composed of a left 2D image for pixels corresponding to odd rows of the image and a right 2D image for pixels corresponding to even rows of the image in an interlaced manner. Accordingly, the resolution of the 3D image may be greater than the resolution of one 2D image. For example, when the resolution of the 2D image is 1920×1080, the resolution of the 3D image may be 1920×2160.

Referring to FIG. 5D, a 3D image may be composed of two 2D images in a solo left and solo right manner. In other words, the left 2D image and the right 2D image may be stored separately, and the right 2D image and the left 2D image may be reconstructed into a single frame. Accordingly, the resolution of the 3D image is the same as the resolution of one 2D image, but the frame rate of the 3D image may be greater than the frame rate of the 2D image. Here, the frame rate is the number of image frames played in a unit of time, which may be expressed in frames per second (FPS) or Hz.

In this case, when the frame rate of the 2D image is fixed, the frame rate of the 3D image may be twice the frame rate of the 2D image. For example, when the left 2D image and the right 2D image have a frame rate of 60 Hz, the 3D image may have a frame rate of 120 Hz.

Meanwhile, the processor 150 may obtain luminance information of the input image based on a grayscale of the input image using the image analysis module 11. Further, based on the obtained luminance information, the processor 150 may identify at least one of a magnitude or application time of current applied to the plurality of LED pixels.

The processor 150 may then use the image analysis module 11 to identify whether the input image is a 2D image or a 3D image. The processor 150 may identify whether the input image is a 2D image or a 3D image based on information related to the input image. The information related to the input image may include header information of the input image, the resolution of the input image, and the frame rate of the input image.

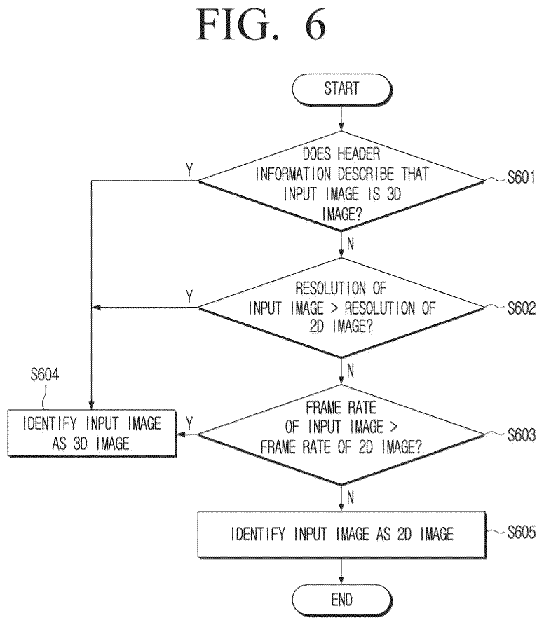

Accordingly, the processor 150 may use the image analysis module 11 to identify whether the input image is a 3D image based on at least one of the header information of the input image, the resolution information of the input image, or the frame rate of the input image. Hereinafter, the process of identifying whether the input image is a 2D image or a 3D image will be described with reference to FIG. 6.

FIG. 6 is a block diagram provided to explain a process of identifying a 3D image according to an embodiment.

Referring to FIG. 6, the processor 150 may use the image analysis module 11 to identify whether the header information of the input image indicates that the input image is a 3D image (S601). When the header information of the input image indicates that the input image is a 3D image, the input image may be identified as a 3D image (S604).

In addition, the processor 150 may identify whether the resolution of the input image is greater than the resolution of the 2D image (S602). The 3D image may have a left 2D image and a right 2D image arranged left and right or up and down. Accordingly, when the resolution of the input image is greater than the resolution of the 2D image, the processor 150 may identify the input image as a 3D image (S604).

Further, the processor 150 may identify whether the frame rate of the input image is greater than the frame rate of the 2D image (S603). One frame of the 3D image may be composed of one frame of the left 2D image and one frame of the right 2D image. Accordingly, when the frame rate of the input image is greater than the frame rate of the 2D image, the processor 150 may identify the input image as a 3D image (S604).

When the header information of the input image does not indicate that the input image is a 3D image, the resolution of the input image is not greater than the resolution of the 2D image, and the frame rate of the input image is not greater than the frame rate of the 2D image, the processor 150 may identify the input image as a 2D image (S605).

Meanwhile, when the input image is identified as a 2D image, the processor 150 may control the driving unit 120 to control the current applied to the plurality of LED pixels based on at least one of the identified magnitude or application time of the current based on a grayscale of the input image using the image analysis module 11.

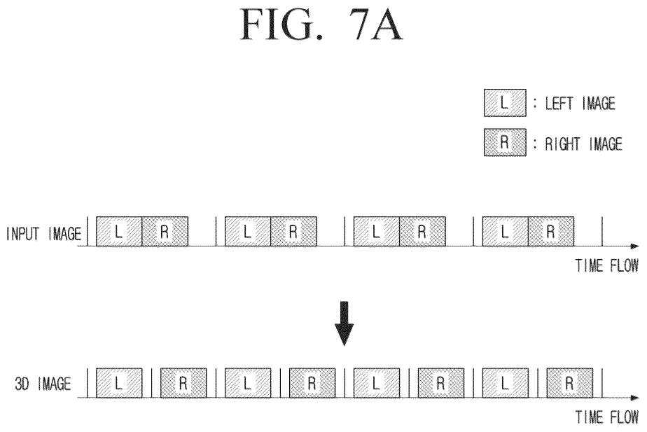

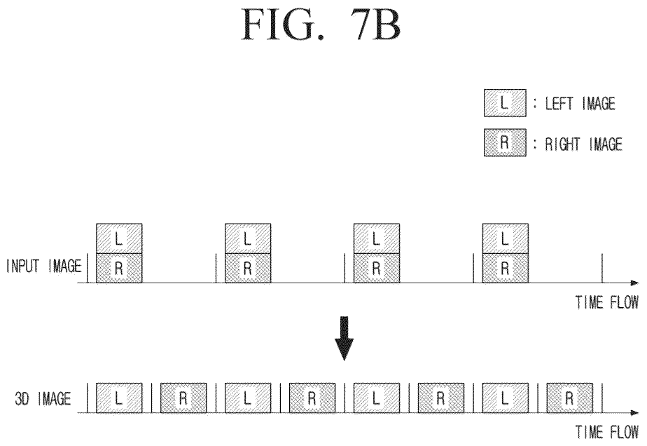

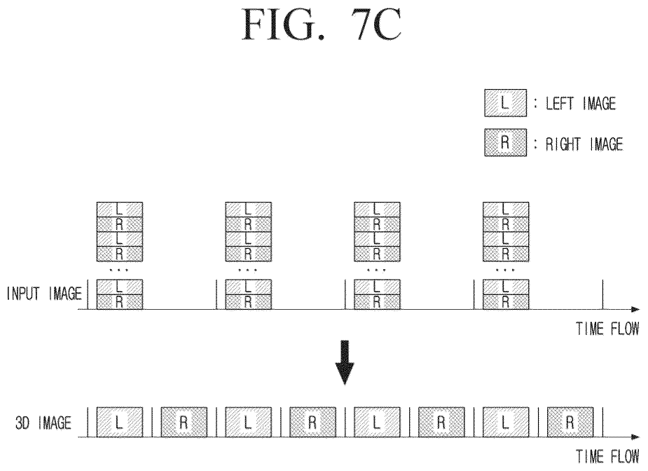

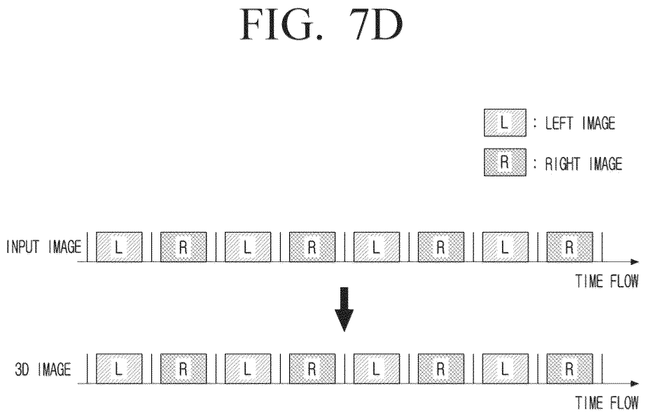

Meanwhile, when the input image is identified as a 3D image, the processor 150 may obtain a left image and a right image included in the input image using the LED driving signal conversion module 12. Hereinafter, the process of obtaining a left image and a right image included in an input image according to an embodiment will be described with reference to FIGS. 7A to 7D.

FIGS. 7A to 7D are views provided to explain a process of obtaining a left image and a right image included in an input image according to an embodiment.

Referring to FIGS. 7A to 7D, the processor 150 may use the LED driving signal conversion module 12 to obtain a left image and a right image included in an input image.

According to an embodiment, a 3D image may be received in which left and right images are mixed in various ways. For example, a 3D image may be received in a form in which the left and right images are mixed in one of the following methods: side by side, top by bottom, interlaced, solo left and solo right.

For example, as shown in FIG. 7A, when a 3D image of a side by side method is received, the processor 140 may divide the input image in the longitudinal direction to obtain the left image and the right image of the 3D image. For example, when the resolutions of the left image and the right image are the same, the processor 150 may obtain the left image and the right image by dividing the input image into left and right with reference to the longitudinal direction from the center of the transverse direction of the input image.

For example, as shown in FIG. 7B, when a 3D image of a top by bottom method is received, the processor 150 may divide the input image in the transverse direction to obtain the left image and the right image of the 3D image. For example, when the resolutions of the left image and the right image are the same, the processor 150 may obtain the left image and the right image by dividing the input image into top and bottom with reference to the transverse direction from the center of the longitudinal direction of the input image.

For example, as shown in FIG. 7C, when a 3D image of an interlaced method is received, the processor 150 may obtain a left image and a right image based on a pixel value of rows corresponding to the left image and the right image. For example, when the left image is disposed in the odd row pixels of the input image and the right image is disposed in the even row pixels of the input image, the left image may be obtained based on the odd row pixels, and the right image may be obtained based on the even row pixels.

For example, as shown in FIG. 7D, when a 3D image of a solo left and solo right method is received, a left image and a right image may be obtained based on the order of the left image and the right image.

Meanwhile, the processor 150 may generate a synchronization signal for a 3D image and 3D glasses using the synchronization signal generation module 13 (S305). Specifically, the processor 150 may generate a 3D synchronization signal corresponding to the display timing of the left image and the right image. For example, the processor 150 may generate a 3D synchronization signal that causes the left lens of the 3D glasses to be in an open state and the right lens to be in a closed state based on the Vsync signal of the left image. Then, the processor 150 may generate a 3D synchronization signal that causes the left lens of the 3D glasses to be in a closed state and the right lens to be in an open state based on the Vsync signal of the right image. Such 3D synchronization signals may be generated simultaneously with the corresponding Vsync signals for the left image and the right image, respectively, or may be generated before the 3D image is displayed on the display 110.

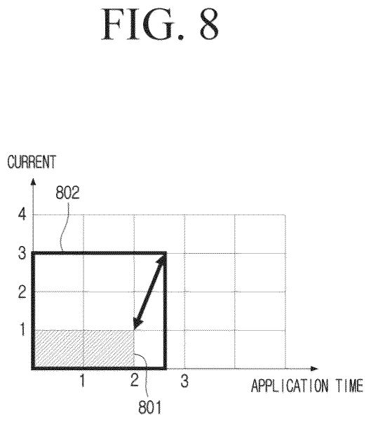

Subsequently, the processor 150 may transmit the generated 3D synchronization signals to the 3D glasses through the communication interface 130. The open or closed state of the left lens and the right lens of the 3D glasses may be controlled by the 3D synchronization signals. Hereinafter, the method of adjusting the luminance of an image will be described with reference to FIG. 8.

FIG. 8 is a view provided to explain the luminance adjustment module 14 according to an embodiment.

Referring to FIG. 8, the processor 150 may adjust the luminance of the LED pixels by adjusting the magnitude or application time of the current applied to the plurality of LEDs included in the display 110 using the luminance adjustment module 14. Specifically, the processor 150 may control the driving unit 120 such that at least one of the identified magnitude or application time of the current is increased while the left image and the right image are displayed (S306). In other words, as the magnitude of the current applied to the LED pixel may increase, the image luminance increases, and as the magnitude of the current applied to the LED decreases, the image luminance may decrease. In addition, as the application time for applying the current to the LED pixel increases, the image luminance may increase, and as the application time decreases, the image luminance may decrease. Accordingly, the luminance of the image may be determined based on the product of the magnitude and application of the current applied to the corresponding LED pixel.

For example, as shown in FIG. 8, when the current applied to the LED is 1 A and the application time corresponds to 2 ms, the LED luminance at this time may correspond to an area 801 represented by the product of 1 A and 2 ms. When the current applied to the LED is 3 A and the application time corresponds to 2.6 ms, the LED luminance may correspond to an area 802 represented by the product of 3 A and 2.6 ms. In this case, the luminance when the current applied to the LED is 1 A and the application time is 2 ms may be 3.9 times greater than the luminance when the current applied to the LED is 3 A and the application time is 2.6 ms.

Accordingly, the problem of the luminance of the image being perceived as reduced by the user in the glasses-free 3D method can be resolved.

Meanwhile, when it is identified that the input image is a 3D image, the processor 150 may increase at least one of the identified magnitude or application time of the current such that the luminance of the input image is increased by a preset ratio while the left image and the right image are displayed. Here, the preset ratio may be identified based on the luminance reduction rate resulting from alternately displaying the left image and the right image and the luminance reduction rate due to the transmittance of the 3D glasses. In other words, the preset ratio may be identified as an increase ratio that can represent the original luminance of the input image based on the luminance reduction rate.

In one example, since a 3D image is transmitted to the user through one lens of the 3D glasses 200, the 3D image may be recognized at a 50% luminance of the luminance set for the display 110. In addition, since the 3D image passes through the lens of the 3D glasses 200, the 3D image may be recognized at a 30 to 50% luminance of the luminance set for the display 110 due to the transmittance of the light of the lens itself. Therefore, the 3D image may be recognized at a luminance that is about 4 times lower than the luminance set for the display 110.

Finally, when the input image is identified as a 3D image, the processor 150 may increase at least one of the identified magnitude or application time of the current such that the luminance of the input image is increased by four times while the left image and the right image are displayed. In other words, the processor 150 may control the driving unit 120 such that the product of the ratio of the increased current and the increased application time becomes four times, such as by increasing the magnitude of the current applied to the LEDs by four times or increasing the application time by four times.

As described above, the preset ratio may be identified based on the luminance reduction rate resulting from alternately displaying the left and right images and the luminance reduction rate due to the transmittance of the 3D glasses. Accordingly, the preset ratio may be 4 times or less when using glasses with better transmittance of the 3D glasses. According to an embodiment, when the display 110 includes the plurality of display modules 110-1, . . . 110-n as shown in FIG. 2B, the driving unit 120 may include a plurality of driving modules connected to the plurality of display modules. In this case, the processor 150 may adjust the preset ratio based on peak luminance information corresponding to each of the plurality of display modules.

For example, when at least one of the peak luminance information corresponding to each of the plurality of display modules is lower than the luminance corresponding to the preset ratio the processor 150 may adjust the preset ratio based on the at least one of the peak luminance information.

Further, the processor 150 may adjust the preset ratio based on peak luminance information corresponding to each of the plurality of display modules 110-1, . . . 110-n. Here, the peak luminance information may be determined based on device characteristics of the LEDs included in each of the plurality of display modules 110-1, . . . 110-n.

For example, it is assumed that the maximum current according to the peak luminance of the first display module 110-1 is 2.5 A, and the maximum current according to the peak luminance of the second display module 110-2 is 3 A. In this case, when the current intensity according to the luminance increase of the image identified based on the luminance reduction rate resulting from alternately displaying the left image and the right image and the luminance reduction rate due to the transmittance of the 3D glasses is 3 A, the processor 150 may adjust the luminance increase rate to be reduced in accordance with 2.5 A according to the peak luminance of the first display module 110-1. However, although the above description is based on the current intensity for convenience of explanation, the same principle can be applied even when based on the description is based on the current application time.

Meanwhile, when the 3D glasses 200 are communicatively connected to another first 3D glasses, the processor 150 may receive transmittance information of the first 3D glasses from the first 3D glasses through the communication interface 130. Even for 3D glasses with the same functionality, the type of lens used may be different for each 3D glasses. Accordingly, the processor 150 may individually receive the transmittance information of the 3D glasses and the transmittance information of the first 3D glasses.

Then, the processor 150 may identify the preset ratio based on the received transmittance information and the luminance reduction rate resulting from alternately displaying the left image and the right image.

Specifically, for a lens with relatively high light transmittance, the luminance reduction rate of the LED may be relatively small. Conversely, for a lens with relatively low light transmittance, the luminance reduction rate of the LED may be relatively large. Accordingly, the processor 150 may adjust the preset ratio based on at least one of a minimum value, a maximum value, and an average value of the transmittance information.

For example, when the transmittance information of the 3D glasses is 50% and the transmittance information of the first 3D glasses is 30%, the processor 150 may determine the luminance reduction rate by the 3D glasses as an average value of 40%. Subsequently, the processor 150 may identify the preset ratio as 5 times by considering both the luminance reduction rate of 50% resulting from alternately displaying the left and right images and the luminance reduction rate of 40% due to the 3D glasses. Hereinafter, the method of adjusting luminance by considering the transmittance of a plurality of 3D glasses will be described.

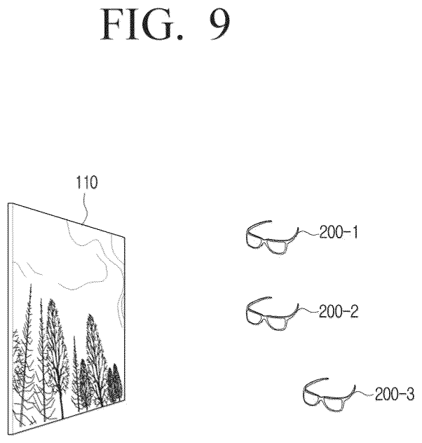

FIG. 9 is a view provided to explain a case where there are a plurality of 3D glasses according to an embodiment.

According to an embodiment, when a plurality of 3D glasses are communicatively connected, the processor 150 may receive a plurality of transmittance information through the communication interface 130 from the plurality of 3D glasses. In this case, the processor 150 may identify representative transmittance information based on at least one of a minimum value, a maximum value or an average value, or a median value of the plurality of transmittance information received. The processor 150 may then identify a preset ratio based on the identified representative transmittance information and the luminance reduction rate resulting from alternately displaying the left image and the right image.

Referring to FIG. 9, when 3D glasses and a plurality of 3D glasses 200-1, 200-2, 200-3 are communicatively connected, the processor 150 may receive a plurality of transmittance information from the plurality of 3D glasses 200-1, 200-2, 200-3 through the communication interface 130. Even for 3D glasses with the same functionality, the type of lens used for the plurality of 3D glasses may be different. Accordingly, the processor 150 may receive the plurality of transmittance information of the plurality of 3D glasses 200-1, 200-2, 200-3.

For example, when the plurality of transmittance information of the plurality of 3D glasses 200-1, 200-2, and 200-3 is 30%, 45%, and 50%, respectively, the processor 150 may receive the plurality of transmittance information of the plurality of 3D glasses 200-1, 200-2, and 200-3 through the communication interface 130.

Subsequently, the processor 150 may identify representative transmittance information based on at least one of a minimum value, a maximum value, an average value, or a median value of the plurality of transmittance information received. For example, when the plurality of transmittance information of the plurality of 3D glasses 200-1, 200-2, and 200-3 is 30%, 45%, and 50%, respectively, the processor 150 may identify the representative transmittance information based on at least one of a minimum value of 30%, a maximum value of 50%, an average value of 40%, and a median value of 45%.

Then, the processor 150 may identify a preset ratio based on the identified representative transmittance information and the luminance reduction rate resulting from alternately displaying the left image and the right image. For example, when the plurality of transmittance information of the plurality of 3D glasses 200-1, 200-2, and 200-3 is 30%, 45%, and 50%, respectively and the representative transmittance information is identified as an average value of 40%, the processor 150 may determine that the luminance reduction rate by the 3D glasses is 40%. Subsequently, the processor 150 may identify the preset ratio as 5 times by considering both the luminance reduction rate of 50% resulting from alternately displaying the left and right images and the luminance reduction rate of 40% due to the 3D glasses.

According to the various embodiments described above, when glasses-type 3D images are provided, the problem of the user perceiving an image at reduced luminance can be resolved, thereby improving user convenience.

Meanwhile, the above-described various embodiments may be implemented as software including instructions stored in machine-readable storage media, which can be read by machine (e.g.: computer). The machine may be a device that invokes the stored instruction from the storage medium and can be operated based on the invoked instruction, and may include a device according to the embodiments disclosed herein. In case that the instruction is executed by the processor, the processor may directly perform a function corresponding to the instruction or other components may perform the function corresponding to the instruction under control of the processor. The instruction may include codes generated or executed by a compiler or an interpreter. The machine-readable storage media may be provided in a non-transitory storage medium. Here, ‘non-transitory storage medium’ merely means that the storage medium is tangible without including a signal (e.g. electromagnetic waves), and does not distinguish whether data are semi-permanently or temporarily stored in the storage medium. For example, the ‘non-transitory storage medium’ may include a buffer in which data is temporarily stored.

According to an embodiment, the methods according to an embodiment may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore™) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server or may be temporarily generated.

Although embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure

What is claimed is:

1. A display device comprising:
a display including a plurality of LED pixels;
a driver configured to drive the display by applying a current to the plurality of LED pixels;
a communication interface;
memory storing at least one instruction; and
one or more processors connected to the display, the communication interface and the memory,
wherein the at least one instruction, when executed by the one or more processors, cause the display device to:
identify at least one of a magnitude of a current or an application time of the current to be applied to the plurality of LED pixels based on luminance information of an input image;
based on the input image being identified as a two-dimensional (2D) image, control the driver to control the current to be applied to the plurality of LED pixels based on the identified at least one of the magnitude of the current or the application time of the current;
based on the input image being identified as a three-dimensional (3D) image, control the driver to obtain a left image and a right image included in the input image and alternately display the left image and the right image;
generate a 3D synchronization signal corresponding to a display timing of the left image and the right image, and transmit the generated 3D synchronization signal to 3D glasses through the communication interface; and
control the driver to increase the identified at least one of the magnitude of the current or the application time of the current while the left image and the right image are displayed.

2. The display device as claimed in claim 1, wherein the at least one instruction, when executed by the one or more processors, cause the display device to identify whether the input image is a 3D image based on at least one of header information of the input image, resolution information of the input image or frame rate of the input image.

3. The display device as claimed in claim 1, wherein the at least one instruction, when executed by the one or more processors, cause the display device to, based on the input image being identified as the 3D image, increase at least one of the identified magnitude of the current or the application time of the current so that luminance of the input image increases by a preset ratio while the left image and the right image are displayed.

4. The display device as claimed in claim 3, wherein the preset ratio is identified based on a luminance reduction rate resulting from alternately displaying the left image and the right image and a luminance reduction rate according to transmittance of the 3D glasses.

5. The display device as claimed in claim 3, wherein the display includes a plurality of display modules,
wherein the driver includes a plurality of driving modules connected to the plurality of display modules, and
wherein the at least one instruction, when executed by the one or more processors, cause the display device to adjust the preset ratio based on peak luminance information corresponding to each of the plurality of display modules.

6. The display device as claimed in claim 5, wherein the at least one instruction, when executed by the one or more processors, cause the display device to, based on at least one peak luminance information corresponding to each of the plurality of display modules being lower than a luminance corresponding to the preset ratio, adjust the preset ratio based on the at least one peak luminance information.

7. The display device as claimed in claim 3, wherein the at least one instruction, when executed by the one or more processors, cause the display device to:
based on the 3D glasses being communicatively connected to another 3D glasses, receive transmittance information of the another 3D glasses from the another 3D glasses through the communication interface; and
identify the preset ratio based on the received transmittance information and a luminance reduction rate resulting from alternately displaying the left image and the right image.

8. The display device as claimed in claim 3, wherein the at least one instruction, when executed by the one or more processors, cause the display device to:
based on the 3D glasses being communicatively connected to a plurality of 3D glasses, receive a plurality of transmittance information from the plurality of 3D glasses through the communication interface;
identify representative transmittance information based on at least one of a minimum value, a maximum value, an average value, or a median value of the received plurality of transmittance information; and
identify the preset ratio based on the identified representative transmittance information and a luminance reduction rate resulting from alternately displaying the left image and the right image.

9. A controlling method of a display device comprising a display that includes a plurality of LED pixels, the method comprising:
identifying at least one of a magnitude of a current or an application time of the current to be applied to the plurality of LED pixels based on luminance information of an input image;
based on the input image being identified as a two-dimensional (2D) image, controlling the current to be applied to the plurality of LED pixels based on the identified at least one of the magnitude of the current or the application time of the current;
based on the input image being identified as a three-dimensional (3D) image, obtaining a left image and a right image included in the input image and alternately displaying the left image and the right image;
generating a 3D synchronization signal corresponding to a display timing of the left image and the right image, and transmitting the generated 3D synchronization signal to 3D glasses; and
increasing the identified at least one of the magnitude of the current or the application time of the current while the left image and the right image are displayed.

10. The controlling method as claimed in claim 9, further comprising:
identifying whether the input image is a 3D image based on at least one of header information of the input image, resolution information of the input image or frame rate of the input image.

11. The controlling method as claimed in claim 9, wherein the increasing at least one of the magnitude of the current or the application time of the current comprises, based on the input image being identified as a 3D image, increasing at least one of the identified magnitude of the current or the application time of the current so that luminance of the input image increases by a preset ratio while the left image and the right image are displayed.

12. The controlling method as claimed in claim 11, wherein the preset ratio is identified based on a luminance reduction rate resulting from alternately displaying the left image and the right image and a luminance reduction rate according to transmittance of the 3D glasses.

13. The controlling method as claimed in claim 11, wherein the display device includes a plurality of display modules and a plurality of driving modules connected to the plurality of display modules, and
wherein the controlling method further comprises:
adjusting the preset ratio based on peak luminance information corresponding to each of the plurality of display modules.

14. The controlling method as claimed in claim 13, further comprising:
based on at least one peak luminance information corresponding to each of the plurality of display modules being lower than a luminance corresponding to the preset ratio, adjusting the preset ratio based on the at least one peak luminance information.

15. The controlling method as claimed in claim 11, further comprising:
based on the 3D glasses being communicatively connected to another 3D glasses, receive transmittance information of the another 3D glasses from the another 3D glasses through the communication interface; and
identify the preset ratio based on the received transmittance information and a luminance reduction rate resulting from alternately displaying the left image and the right image.

16. The controlling method as claimed in claim 11, further comprising:
based on the 3D glasses being communicatively connected to a plurality of 3D glasses, receive a plurality of transmittance information from the plurality of 3D glasses through the communication interface;
identify representative transmittance information based on at least one of a minimum value, a maximum value, an average value, or a median value of the received plurality of transmittance information; and
identify the preset ratio based on the identified representative transmittance information and a luminance reduction rate resulting from alternately displaying the left image and the right image.

17. A non-transitory computer-readable recording medium storing a computer instruction that, when executed by a processor of a display device comprising a display that includes a plurality of LED pixels, causes the display device to:
identify at least one of a magnitude of a current or an application time of the current to be applied to the plurality of LED pixels based on luminance information of an input image;
based on the input image being identified as a 2D image, control the current to be applied to the plurality of LED pixels based on the identified at least one of the magnitude of the current or the application time of the current;
based on the input image being identified as a 3D image, obtain a left image and a right image included in the input image and alternately display the left image and the right image;
generate a 3D synchronization signal corresponding to a display timing of the left image and the right image, and transmit the generated 3D synchronization signal to 3D glasses; and
increase the identified at least one of the magnitude of the current or the application time of the current while the left image and the right image are displayed.

18. The computer-readable recording medium of claim 17, further comprising:
identifying whether the input image is a 3D image based on at least one of header information of the input image, resolution information of the input image or frame rate of the input image.

19. The computer-readable recording medium of claim 17, wherein the increasing at least one of the magnitude of the current or the application time of the current comprises, based on the input image being identified as a 3D image, increasing at least one of the identified magnitude of the current or the application time of the current so that luminance of the input image increases by a preset ratio while the left image and the right image are displayed.

20. The computer-readable recording medium of claim 19, wherein the preset ratio is identified based on a luminance reduction rate resulting from alternately displaying the left image and the right image and a luminance reduction rate according to transmittance of the 3D glasses.
